(19) United States
(12) Patent Application Publication
(10) Pub. No.: US 2007/0042614 A1
(43) Pub. Date: Feb. 22, 2007

(54) Dynamically illuminated product display system apparatus and method

(75) Inventors: George Marmaropoulos, Yorktown Heights, NY (US); Jack Kyriakos Mama, London (GB); Clive R. Heerden, London (GB); Philippa Clare Wagner, London (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/574,441

(22) PCT Filed: Oct. 1, 2004
(86) PCT No.: PCT/IB04/51953

§ 371 Date: Mar. 31, 2006

Related U.S. Application Data
(60) Provisional application No. 60/508,718, filed on Oct. 3, 2003.

(51) Int. Cl. H01R 33/00

(52) U.S. Cl. 439/37

(57) ABSTRACT

A dynamically illuminated product display device, system, and method includes a shelf 110 having a series of electrical contacts 120 arranged on an upper surface thereon, the shelf being adapted for connection with a power source. A package 101 covers at least a portion of a product, the package having an electro luminescent material 105 arranged on at least a portion of an exterior surface and electrical contacts 115 arranged on a portion of a bottom surface and in electrical connection with the electro luminescent material 1051, so that when the package is arranged on the shelf, the electrical contacts 115 on the bottom surface of the package 101 are facing the electrical contacts 120 arranged on the shelf 110. The product package can display a backlight, an image such as a product logo, or part or a whole message to enhance the possibility of consumer selection.

### APPARATUS AND METHOD

The present invention relates to electronic product displays. More particularly, the present invention relates to electronic displays of consumer goods that illuminate the goods displayed on store shelves.

In a commercial environment, it is becoming increasingly difficult to distinguish one's products on the shelf from other products, many of which often are the same size and use many of the same colors in the packaging in an attempt to “knock off” purchases of one's product by confusing the consumer. Although certain shades of colors under strict circumstances have been trademarked, this is very difficult to obtain and normally could not be acquired for common colors of product packaging.

Sometimes manufacturers have arranged coupon dispensers that are attached to the shelf, with the dispenser having a blinking light and/or making a sound to catch the attention of a shopper. The hope is that with the advantage of dispensing a coupon at the product site, the consumer will be enticed to purchase that particular brand due to the added savings. However, there is a limit as to how many coupon dispensers can be displayed in a store, and even so, the product itself is not being displayed any differently than other competing products. In fact, products today are not displayed very differently than they were in the first supermarkets at beginning of the 20^{th} century.

Accordingly, there is a need in the art to improve the display of items in a store that is in line with the taste of modern shoppers. Moreover, many marketers are now trying to move shopping to another level, i.e. “a shopping experience”; this is particularly true of stores such as cosmetic stores.

The present invention provides a system, method, and a product packaging that is heretofore unknown in the art. According to the present invention, the product packaging is dynamically illuminated.

According to an aspect of the invention, an electro luminescent material I that is arranged on a surface of the packaging is connected via conductive ink (printed conductive ink) to a pair of contacts on the lower portion or back of the packaging. When a power source comes into contact with pair of contacts, the electrolumines cent material lights up, thus illuminating the product package.

The illumination of the product package may comprise a background hue, or the drawings on the package could be a print screened logo on the front of the box with the conductive ink, so that the product displays its logo in luminescence.

In another aspect of the invention, nano-wire leds could also be arranged on the box to form a design pattern. Such nano-leds perform essential as pixels in the primary colors of red, blue and green, and can be used to make virtually any color combination.

In another aspect of the invention, a method involves the product packaging being used to display moving images and text, with advertising slogans and other messages being displayed across the front of the packages.

In yet another aspect of the invention, a plurality of shelves wired with electronic contacts are adapted to receive a plurality of product packages that are adapted for illumination. The packages can be boxes, bottles, jars, etc. If the packaging is transparent, the actual product can be illuminated. The packages are stocked on the shelves and essentially form a matrix of pixels, with each individual package representing a pixel or group of pixels. A control unit is programmed to either illuminate the packages, display a stationary message, or provide a “rolling message” that cycles its way through the path of the lighted packages.

The control unit can be programmed to vary the amount of illumination of certain boxes on the shelf, so that certain stock which is more desirable for a store to sell first can be illuminated the most, wherein less profitable stock could be illuminated but have a lower degree of brightness. In addition, perishable items could be more brightly illuminated so as to induce their purchase ahead of other items on the adjacent shelves

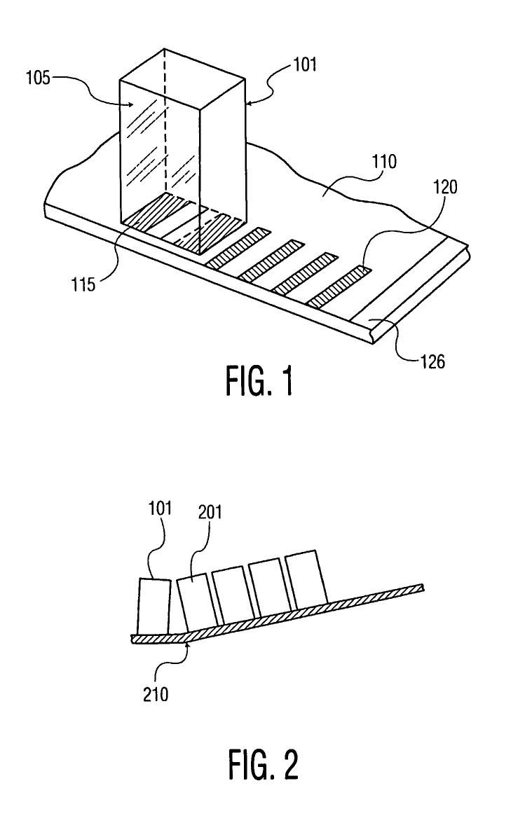

FIG. 1 is an illustration an electro luminescent packaging system according to a first aspect of the present invention.

FIG. 2 illustrates a second aspect of the present invention, wherein the shelf is formed with an angle to always keep an electro-illuminated package at the front of the shelf.

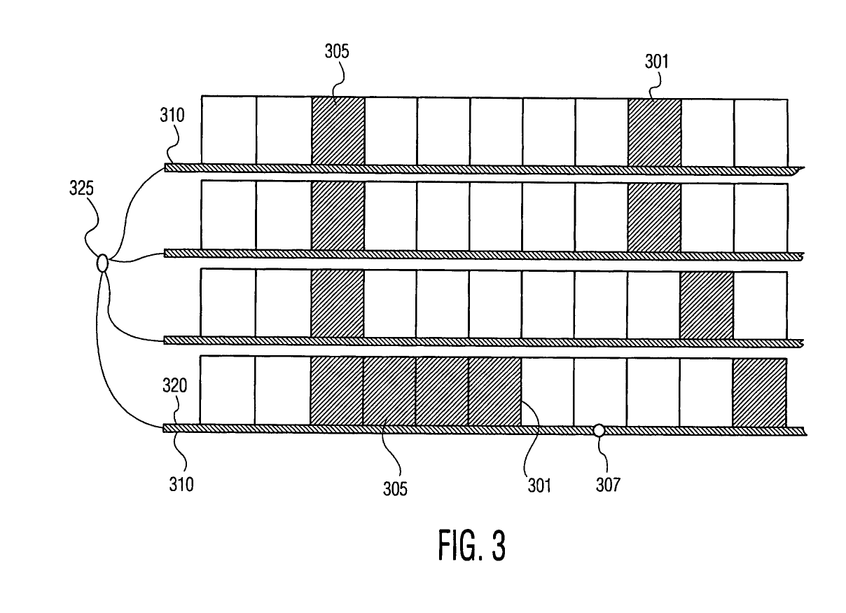

FIG. 3 illustrates a plurality of products that are illuminated as though they were individual pixels in a matrix.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 is an illustration of a first aspect of the present invention. A first package 101 is shown positioned on a shelf 110. It should be noted that as the drawing figures are presented for purposes of explanation and not for limitation, in no way is the present invention limited to rectangular boxes, as the package could take any shape, for example, square, circular, oblong, parallel-piqued, irregular, polygonal, triangular, elliptical. The package might be a bottle, container, fluid-holding vessel, etc. In a best mode, the lower portion of the package is flat so as to be accommodate electrical contact between contacts 115 on the package 101 and contacts 120 on the store shelf 110, with gravity acting as a force that keeps the product package 101 on the contacts 120.

Similar to the description regarding the package, the electrical contacts could be vertically arranged on a lower portion of the box, horizontally arranged, diagonally arranged, may comprise circular or semi-circular contact area areas and could be recessed in the package, or extend from the package. If the contacts extend from the package, it would be presumed that the shelf 110 may have recessed contacts that accept the extensions protruding from the package 101. Although two contacts are shown on the lower portion of the package 101, there could be a plurality of contacts, for example, in which the voltages add, such as a series connection of 1.5 volt contacts that are additive so as to obtain 6 volts, or 9 volts, etc. Again, the 1.5 and 6 volt values are mentioned for explanatory purposes only, with the actual voltages being the values best-suited for use with the electro luminescent ink or display material. Low voltage contacts that are additive might be preferable for purposes of safety.

The shelf 110 may include fuses, fusible links and/or circuit breakers (not shown) betweens sets of contacts 120 so as to insure the safety of consumers and store employees in the case of product leakage, if the product, for example, is a conductive liquid, so as to prevent shorting out the shelf portion. Also, other products adjacent the electro luminescent product could also leak, or an item having a completely metallic bottom, such as a can of coffee, could be placed on the shelf inadvertently by a consumer and short the strips of contacts 120, as shoppers sometimes take items out of their wagons and deposit them in other areas of the store, almost at their whim.

As shown in FIG. 2, the shelf 210 may be inclined so that when a first package is removed, another package containing the electro luminescent material shifts or slides downward by gravity and makes contact with the shelf contacts 120. Item 201 will slide downward into the spot currently held by package 101.

The package 101 will have the electro luminescent material preferably on its face. Such material includes but is not limited to electric ink, or ink mixed with an electro luminescent material that will light up after being exposed to a predetermined voltage. There are known substances that turn color, such as white to black, or blue to red, upon being exposed to a changing voltage level. Alternatively, small surface mounted LEDs, including but not limited to nano-leds, could be mounted on the surface of the box. A conductive path from the electrode contact to the leds and back down to a return or ground contact is one way that the package could be wired. There would be relatively low costs involved with wiring.

The type of message displayed could be the standard logo that is on the package, only it is now illuminated with background light, flashing light, or colored light. In addition, the lights could spell out the product name, or they could be a lighted replica of the logo. Finally, the package could actually display messages, such as a rolling or moving message, that could involve other packages adjacent the package 101.

FIG. 3 shows another aspect of the invention, wherein a “wall” of packages 301 are stocked, with select ones turning on and off as though they are in a sense, giant pixels or a plurality of large pixels. There are as series of shelves 310 having electrical contacts 320 similar to those shown in FIGS. 1 and 2, except that a controller 325 controls turning on and off the voltage that illuminates the electro luminescent material 305 of the packages 301 to create the lighted pixel effect. The shelf may optionally contain a sensor 307 including but not limited to an electric eye, which could be a simple infrared or photodiode sensor. When a customer approaches the shelf, the system would power on and light up. When no customers are sensed, the system would either power down fully or partially to a standby status, so as not to waste electricity. The sensor would signal the controller 325 when a shopper is detected within range of the display.

Not only can messages about the products be displayed, but words such as “SALE! 20% OFF” or the actual price could be displayed. Also, information about product content could be displayed, such as “all natural” “vitamin fortified” “for thinning hair” or slogans associated with the product, such as “help build bodies twelve ways”.

In another aspect of the invention, certain rows or packages may have higher degrees of illumination so as to “push” or increase the possibility that a consumer chooses a package from the more brightly light row or package. More profitable items could be illuminated more than, for example, less profitable items. In this case of perishable items, those items closest to expiration dates could be illuminated more than newer stock, or have different messages displayed on them.

Various modifications may be made by persons of ordinary skill in the art to the present invention that would lie within the spirit of the invention and the scope of the appended claims. For example, the product package does not just means packaging, it make comprise a label on a bottle or jar, or an identifying tab arranged on, or part of the product. The messages displayed can be stationary, blinking, or dynamic, meaning that they “roll” across the matrix of pixels (i.e. the letters are shift from left to right across to adjacent packages of product, or even from right to left if desired). There may be a plurality of messages, or just one large message displayed. The lights can be any color, multi -color, and if illuminating the background of a product, different colors. Different amounts of illumination can be provided to the individual packages, for example, to place particular emphasis on certain predetermined packages either because of their expiration date, profitability, need to sell to reach quote, etc.etc.

What is claimed is:

1. A product identifier adapted for dynamic illumination, comprising:
a package 101 that covers at least a portion of a product, said package having an electro luminescent material 105 arranged on at least a portion of an exterior surface and electrical contacts 115 electrically connected to said electro luminescent material 105, said contacts being arranged on a portion of a surface adapted for contact with one of a plurality of shelf contacts and a power source.

2. The product identifier according to claim 1, wherein the electro luminescent material is arranged to display a product logo on the package 101.

3. The product according to claim 1, wherein the electro luminescent material is arranged to provide a background illumination of the package 101.

4. The product according to claim 1, wherein the electro luminescent materia105 is arranged as a matrix of pixels to display one of static and dynamic predetermined messages.

5. A dynamically illuminated product display system, comprising:
a shelf 110 having a series of electrical contacts 120 arranged on an upper surface thereon, said shelf being adapted for connection with a power source;
a package 101 that covers at least a portion of a product, said package having an electro luminescent material 105 arranged on at least a portion of an exterior surface and electrical contacts 115 arranged on a portion of a bottom surface so that when said package is arranged on said shelf, the electrical contacts 115 on the bottom surface of the package 101 are facing the electrical contacts 120 arranged on the shelf 110, said package also having the electrical contacts 115 and said electro luminescent material 105 electrically connected.

6. The system according to claim 5 wherein said electro luminescent material 105 on said package 101 illuminates when said package 101 is electrically connected to said shelf 110, and the power source is connected to said shelf.

7. The system according to claim 5, wherein the electrical contacts 120 of said shelf 110 are arranged only on a front portion of the shelf, so that only when the package 101 is arranged on the front portion of the shelf 120 facing a consumer will the package be illuminated by the system.

8. The system according to claim 5, wherein the shelf is formed on an incline so that when the first package facing the consumer is removed, additionally stocked packages will slide forward toward the front portion of the shelf so that a second package becomes illuminated.

9. The system according to claim 5, wherein a portion of the electro luminescent material comprises conductive ink.

10. The system according to claim 5, wherein a portion of the electro luminescent material comprises a plurality of nano-leds.

11. The system according to claim 5, wherein at least a portion of the electro luminescent material 105 is arranged as a background illumination sub-system for the product package 101.

12. The system according to claim 5, wherein at least a portion of the electro luminescent material is arranged on the package to display an illuminated logo of the product.

13. The system according to claim 5, wherein at least a portion of the electro luminescent material is arranged on the package to display a stationary lighted message.

14. The system according to claim 5, wherein at least a portion of the electro luminescent material is arranged on the package to display two or more stationary lighted messages.

15. The system according to claim 5, wherein the stationary lighted message comprised of at least a portion of the electro luminescent material blinks on and off.

16. The system according to claim 5, wherein at least a portion of the electro luminescent material is arranged on the package to provide a dynamic lighted message.

17. The system according to claim 5, further comprising a controller 126 that controls a brightness of a display of the electro luminescent material 105 on the package 101.

18. The system according to claim 10, where the nano-leds are arranged as a matrix of pixels on the package 101.

19. A dynamically illuminated product display system, comprising:
a plurality of shelves 310 having a series of electrical contacts 320 arranged on a respective upper surface of each shelf,
a matrix of product packages 301 that covers at least a portion of a product, each of said packages having an electro luminescent material 305 arranged on at least a portion of an exterior surface and having electrical contacts 115 electrically connected to the electro luminescent material 305 and arranged on a portion of a lower surface of the packages so that when said packages are arranged on said shelf, the electrical contacts 115 on the lower surface of each respective package 301 face the electrical contacts 320 arranged on the shelves 310,
a controller 325 in electrical connection with the shelves, said controller determining which of the product packages of the matrix are to be illuminated and an amount of illumination displayed;
wherein said matrix being displayed as an arrangement of pixels so that illuminated messages can be displayed across a plurality of product packages 301.

20. The system according to claim 19, further comprising:
a sensor 307 that senses when a consumer is within a predetermined distance of the matrix and signals the controller 325 so that said controller: 1) turns on the illumination; and 2) blinks a message to entice the consumer to read the message.

21. A method for providing product illumination, comprising the steps of
(a) arranging a plurality of shelves 310 having a series of electrical contacts 320 located on a respective upper surface of each shelf,
(b) providing a matrix of product packages 301 that cover at least a portion of a product, each of said packages having an electro luminescent material 305 arranged on at least a portion of an exterior surface and having electrical contacts 115 electrically connected to the electro luminescent material 305 and arranged on a portion of a lower surface of the packages so that when said packages are arranged on said shelf, the electrical contacts 115 on the lower surface of each respective package 301 faces the electrical contacts 320 arranged on the shelves 310, and
(c) determining by a controller 325 in electrical connection with the shelves 310, which product packages 301 of the matrix are to be illuminated, and an amount of illumination to be displayed.

22. The method according to claim 21, wherein step (c) further includes illuminating the matrix of product packages with different amounts of illumination to entice a consumer to choose the most brightly illuminated packages.

23. The method according to claim 22, wherein the most brightly illuminated packages are products which are closest to a product expiration date.

24. The method according to claim 22, wherein the most brightly illuminated packages are the most profitable packages arranged on the shelves.

25. The method according to claim 22, wherein step (c) includes wherein said matrix being displayed as an arrangement of pixels so that illuminated messages can be displayed across a plurality of product packages 301 used as one or more pixels to create images.
